(19) United States
(12) Patent Application Publication
(10) Pub. No.: US 2019/0118500 A1
(43) Pub. Date: Apr. 25, 2019

(54) FORMING APPARATUS AND FORMING METHOD

(71) Applicant: SUMITOMO HEAVY INDUSTRIES, LTD., Tokyo (JP)

(72) Inventor: Kei Yamauchi, Ehime (JP)

(21) Appl. No.: 16/230,052

(22) Filed: Dec. 21, 2018

Related U.S. Application Data
(63) Continuation of application No. PCT/JP2017/024701, filed on Jul. 5, 2017.

(30) Foreign Application Priority Data
Jul. 6, 2016 (JP) 2016-134237

(51) Int. Cl. B30B 1/34; B21D 37/14; B30B 15/22

(52) U.S. Cl. CPC B30B 1/34; B30B 15/22; B21D 37/14

(57) ABSTRACT

A forming apparatus includes: a slide on which one of a pair of dies is mounted and which has a hole portion and can advance and retreat in an advancing and retreating direction; a die clamping force generating unit having a piston movable in the advancing and retreating direction and generating a die clamping force; a slide driving unit advancing and retreating the slide in the advancing and retreating direction; and a die clamping force transmitting unit which transmits the die clamping force from the die clamping force generating unit to the slide and includes a force transmitting body transmitting the die clamping force from the piston to the slide and movable between a first position to prevent the piston from entering the hole portion and a second position to allow the piston to enter the hole portion, and a force transmitting body driving unit moving the force transmitting body.

### RELATED APPLICATIONS

Priority is claimed to Japanese Patent Application No. 2016-134237, filed Jul. 6, 2016, and International Patent Application No. PCT/JP2017/024701, the entire content of each of which is incorporated herein by reference.

### BACKGROUND

### Technical Field

Certain embodiments of the present invention relate to a forming apparatus and a forming method.

### Description of Related Art

As one of forming apparatuses using a die, there is a press machine which advances and retreats the die by using a hydraulic cylinder and a piston and presses a workpiece with the die. The related art discloses a hydraulic press machine which includes a rod (a piston) which strokes in the interior of a main cylinder by using hydraulic pressure, a slide, driving of which is controlled by a slide elevating cylinder, an elongation rod which is placed on the slide and can be inserted into an insertion hole provided in the rod, and a shutter which opens and closes the insertion hole. In this hydraulic press machine, after the slide is moved down by the slide elevating cylinder to pull out the elongation rod from the insertion hole, the shutter is moved between the rod and the elongation rod so as to close the insertion hole. Thereafter, the rod is moved down, and the slide is moved down through the shutter and the elongation rod, whereby the stroke of the rod is shortened, and thus improvement in working efficiency is attained.

### SUMMARY

According to an embodiment of the present invention, there is provided a forming apparatus for forming a workpiece by performing die-closing of a pair of dies, includes: a slide on which one of the pair of dies is mounted and which can advance and retreat in an advancing and retreating direction which is a direction toward the other die; a die clamping force generating unit which includes a piston movable in the advancing and retreating direction by supplying hydraulic oil thereto and generates a die clamping force; a slide driving unit which advances and retreats the slide in the advancing and retreating direction; and a die clamping force transmitting unit which transmits the die clamping force from the die clamping force generating unit to the slide, in which the slide includes a hole portion into which the piston can be inserted, and the die clamping force transmitting unit includes a force transmitting body which is movable between a first position where the force transmitting body covers the hole portion to prevent the piston from entering the hole portion and a second position where the force transmitting body retreats from the first position to allow the piston to enter the hole portion, and transmits the die clamping force from the piston to the slide when the force transmitting body is located at the first position, and a force transmitting body driving unit which moves the force transmitting body.

Further, according to another embodiment of the present invention, there is provided a forming method including: inserting a piston of a die clamping force generating unit into a hole portion provided in a slide; advancing the slide in a direction in which dies are put together such that the piston is located outside the hole portion of the slide; advancing a die clamping force transmitting unit to a position between the slide and the piston, which prevents the piston from entering the hole portion; advancing the piston in the direction in which the dies are put together; and performing die-clamping of the dies through the die clamping force transmitting unit and the slide.

### BRIEF DESCRIPTION OF THE DRAWINGS

FIG. 1 is a schematic configuration diagram of a forming apparatus.

FIG. 2 is a plan view showing a slide.

FIGS. 3A and 3B are plan views showing a detailed structure of a die clamping force transmitting unit, in which FIG. 3A shows a state where a hole portion is exposed and FIG. 3B shows a state where the hole portion is covered with a block body.

FIG. 4 is a diagram showing a manufacturing process by the forming apparatus.

FIG. 5 is a diagram showing the manufacturing process by the forming apparatus, which follows FIG. 4.

### DETAILED DESCRIPTION

In a case where the insertion hole is provided in the rod, as in the hydraulic press machine described above, it is necessary to increase the size of the rod in order for the rod to withstand a large load acting on the rod at the time of forming of a workpiece. For this reason, the main cylinder and the like for driving the rod also tend to be increased in size. In the hydraulic press machine as described above, it is required to make the rod, the main cylinder, and the like compact while maintaining working efficiency.

It is desirable to provide a forming apparatus and a forming method, in which it is possible to realize compactification of a die clamping force generating unit having a piston.

According to the forming apparatus, a piston capable of advancing and retreating in the advancing and retreating direction is made to be able to be inserted into the hole portion provided in the slide. In this way, when the slide is retreated further toward the base end side than the tip of the piston, it is not necessary to a hole or the like, into which a rod is inserted, in the piston, as in the related art. Therefore, it is possible to prevent the piston from becoming large in excess of a cross-sectional area which generates the required die clamping force. Further, the forming apparatus has the die clamping force transmitting unit having the force transmitting body for transmitting the die clamping force from the piston to the slide when the force transmitting body is located at the first position where the force transmitting body covers the hole portion to prevent the piston from entering the hole portion. In this way, when the die-clamping of the dies is performed, the force transmitting body is located at the first position, whereby the die clamping force from the piston can be favorably transmitted to the die through the force transmitting body and the slide. In addition, since the amount of movement of the piston can be reduced due to using the die clamping force transmitting unit, the portion to which the hydraulic oil is supplied in the die clamping force generating unit can also be reduced in size. That is, compactification of the die clamping force generating unit having the piston can be realized.

Here, when the slide advances and retreats by the slide driving unit, the piston may be slidable with respect to the slide in the hole portion. In this case, the slide and the piston can be independently advanced and retreated.

Further, the forming apparatus may further include a control unit which controls driving of each of the die clamping force generating unit and the slide driving unit, and the control unit may control the slide driving unit such that the slide advances in the advancing and retreating direction, and then control the die clamping force generating unit such that the piston advances in the advancing and retreating direction. Due to such a control of the control unit, the slide and the piston can be independently advanced and retreated. For this reason, the control unit can control the driving of the piston so as to apply a high die clamping force to the slide, while controlling the slide to be driven at high speed by the slide driving unit. In this way, in one forming cycle in the forming apparatus, it is possible to achieve both reduction in cycle time and occurrence of a high die clamping force.

Further, the die clamping force transmitting unit may be controlled to advance and retreat in a perpendicular direction orthogonal to the advancing and retreating direction. In this case, the advancing and retreating directions of the piston and the slide and the advancing and retreating direction of the die clamping force transmitting unit are orthogonal to each other. In this way, for example, after the slide moves down, the die clamping force transmitting unit can be easily advanced to the first position between the piston and the slide.

Further, the slide driving unit may include one or a plurality of hydraulic piston cylinders in which sub-pistons advance and retreat by supplying hydraulic oil thereto, and a total value of cross-sectional areas of the sub-pistons may be smaller than a cross-sectional area of the piston. In this case, although the sub-piston cannot apply larger pressure than the piston to the slide, the sub-piston can be driven at higher speed than the piston. For this reason, the slide driving unit can drive the slide at high speed. In addition, although the piston is driven at lower speed than the sub-piston, the piston can apply larger pressure than the sub-piston to the force transmitting body, the slide, and the like. Therefore, in one forming cycle in the forming apparatus, it is possible to achieve both reduction in cycle time due to the high-speed driving of the slide by the slide driving unit and occurrence of a high die clamping force due to the driving of the piston.

Further, a workpiece disposed between the pair of dies may be expansion-formed by performing die-closing of the pair of dies. For example, in a case where the forming apparatus performs forging forming, forming resistance is generated due to contact between a die and a workpiece, and in order to overcome the forming resistance and put the dies together, it is necessary to press the die with a piston. For this reason, in a case where forging forming of a workpiece is performed with the forming apparatus, the piston also has to advance by a certain distance, and thus it is necessary to secure a distance for the stroke of the piston. In contrast, in a case where expansion forming of a workpiece is performed with the forming apparatus, it is favorable if the piston presses the die through the force transmitting body or the like from a state where the die on one side (or the slide) is completely moved down or immediately before the die on one side (or the slide) is completely moved down. In this case, the distance for the stroke of the piston may be shorter than that in forging forming or the like, and a time required for the stroke of the piston can be shortened. Therefore, according to the expansion forming using the forming apparatus, the die clamping force generating unit having the piston can be made more compact and the forming time can be shortened.

According to the forming method, since the piston of the die clamping force generating unit is inserted into the hole portion provided in the slide, when the slide is retreated further toward the base end side than the tip of the piston, it is not necessary to provide a hole or the like, into which a rod is inserted, in the piston, as in the related art. Therefore, it is possible to prevent the piston from becoming large in excess of a cross-sectional area which generates the required die clamping force. Further, after the die clamping force transmitting unit is advanced to a position where the piston is prevented from entering the hole portion, the piston is advanced in the direction in which the dies are put together, and die-clamping of the dies is performed through the die clamping force transmitting unit and the slide. In this way, the die clamping force from the piston can be favorably transmitted to the die through the die clamping force transmitting unit and the slide. In addition, since the amount of movement of the piston can be reduced due to the die clamping force transmitting unit, the die clamping force generating unit for driving the piston can also be reduced in size. Therefore, compactification of the die clamping force generating unit having the piston can be realized.

Hereinafter, preferred embodiments of a forming apparatus and a forming method according to the present invention will be described with reference to the drawings. In the respective drawings, identical or corresponding parts are denoted by the same reference numerals, and overlapping description is omitted.

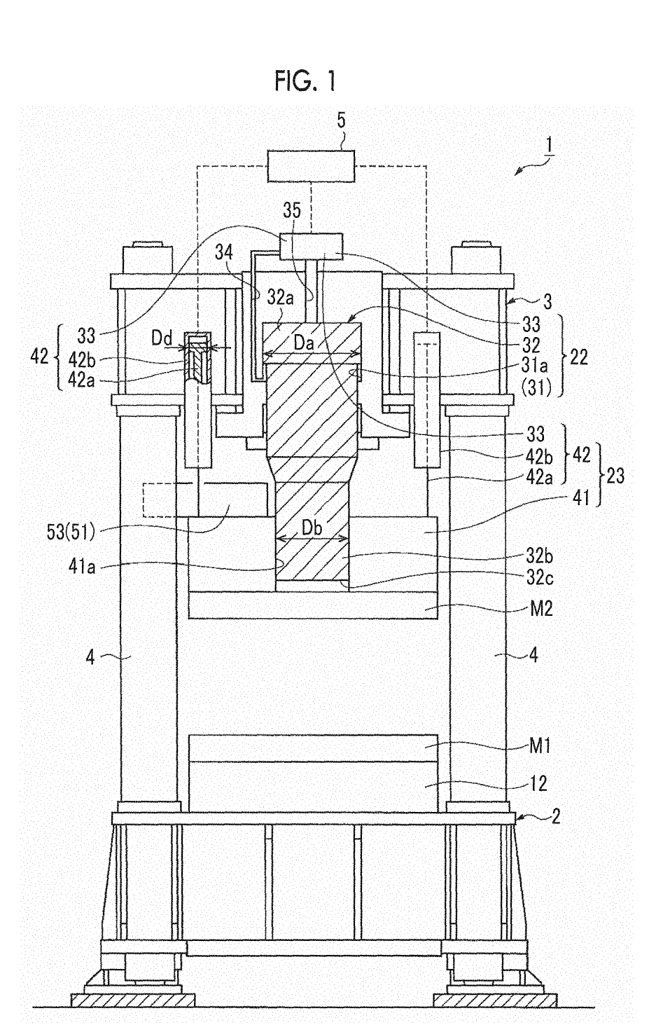

FIG. 1 is a schematic configuration diagram of a forming apparatus. As shown in FIG. 1, a forming apparatus 1 for bringing a pair of dies close to each other to pressure-form a workpiece by the dies includes a lower frame 2 (a bed), an upper frame 3 (a crown), a plurality of columnar frames 4 (uprights) connecting the lower frame 2 and the upper frame 3, a die clamping force generating unit 22 (details will be described later), two slide driving units 42 (details will be described later), and a control unit 5 that controls driving of each of the die clamping force generating unit 22 and the slide driving units 42. Each of the lower frame 2, the upper frame 3, and the columnar frame 4 is configured by combining members made of steel, for example. In the following, an extension direction of the columnar frame 4 is set to be an elevating direction, and a direction orthogonal to the elevating direction is set to be a horizontal direction. In this embodiment, the workpiece is formed by advancing and retreating at least one of the dies in the elevating direction. That is, in this embodiment, the elevating direction corresponds to a direction in which the dies are put together.

The lower frame 2 is provided with a bed 12 (a bolster) to which a lower die M1 is mounted and fixed. The lower die M1 is configured of a steel block, and a forming surface (not shown) for forming a forming space is provided on the upper surface thereof.

The upper frame 3 is provided with the die clamping force generating unit 22 provided at the center thereof, and a die driving unit 23 which supports and drives an upper die M2. The upper die M2 is configured of a steel block similar to the lower die M1, and a forming surface (not shown) for forming a forming space is provided on the lower surface thereof.

The die clamping force generating unit 22 is a mechanism which generates a die clamping force that prevents die-opening of the pair of dies when forming the workpiece, and includes a hydraulic cylinder 31, a piston 32 which is slidable in the hydraulic cylinder 31 and is capable of advancing and retreating in the elevating direction, an oil supply unit 33 which supplies hydraulic oil to an oil chamber in the hydraulic cylinder 31.

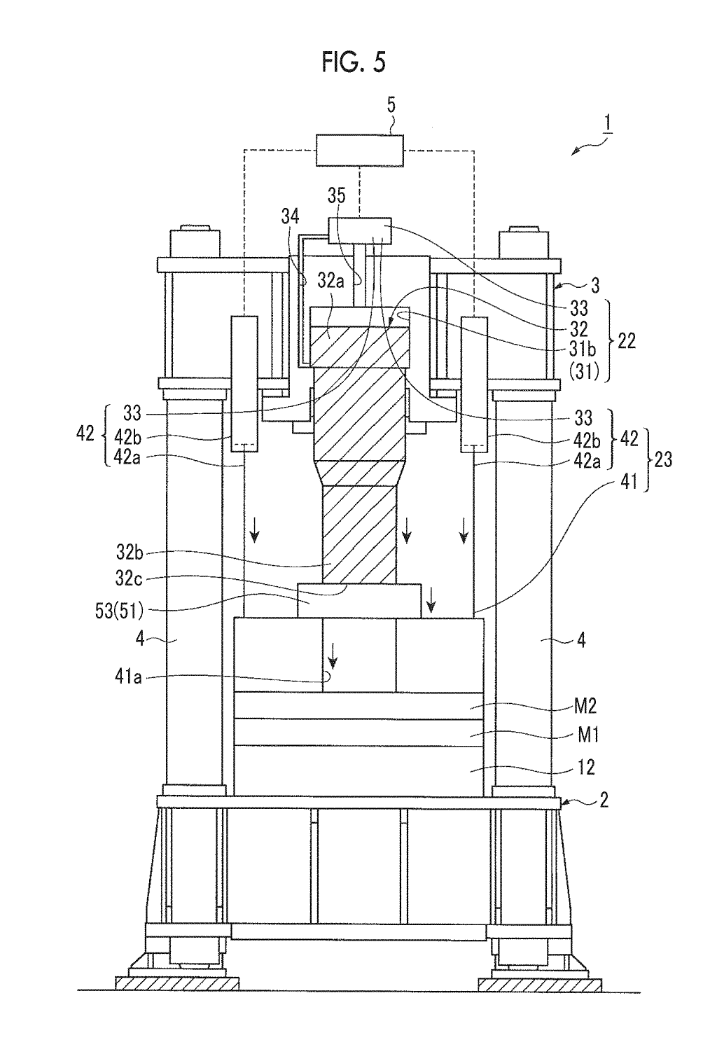

The hydraulic cylinder 31 is a substantially tubular member extending in the elevating direction and has the oil chamber in which the hydraulic oil is accommodated. The interior of the hydraulic cylinder 31 is partitioned into a lower region 31a (refer to FIG. 1) and an upper region 31b (refer to FIG. 5) by a base end portion 32a (details will be described later) of the piston 32. The lower region 31a and the upper region 31b configure the oil chamber. The lower region 31a is connected to the oil supply unit 33 through an oil passage 34, and the upper region 31b is connected to the oil supply unit 33 through an oil passage 35. The amount of hydraulic oil which is filled in the lower region 31a and the upper region 31b is controlled by the oil supply unit 33.

The piston 32 is a member which moves up and down by the hydraulic oil which is supplied into the hydraulic cylinder 31, and is provided with the base end portion 32a which is located at one end (an upper end in FIG. 1) thereof and is in sliding contact with an inner wall of the hydraulic cylinder 31, and a main body portion 32b which is located below the base end portion 32a. The main body portion 32b has a substantially columnar shape extending toward the lower frame 2. A diameter Db of the main body portion 32b is smaller than a diameter Da of the base end portion 32a. A flat tip surface 32c is provided at the other end (a lower end in FIG. 1) of the piston 32. The central axes of the hydraulic cylinder 31 and the piston 32 coincide with each other.

The oil supply unit 33 is a member for supplying the hydraulic oil to the lower region 31a and the upper region 31b of the hydraulic cylinder 31, and is configured of, for example, a tank in which the hydraulic oil is stored, a pump for discharging the hydraulic oil in the tank, and the like. Further, the oil supply unit 33 recovers the hydraulic oil filled in the lower region 31a and the upper region 31b. For example, in a case where the oil supply unit 33 supplies the hydraulic oil to the lower region 31a, the oil supply unit 33 recovers the hydraulic oil filled in the upper region 31b. In this way, the oil supply unit 33 adjusts the volume of the hydraulic oil filled in the lower region 31a and the upper region 31b and controls the position of the piston 32 in the elevating direction. Valves (not shown) are provided in the oil passage 34 and the oil passage 35, and by controlling the valves, it is possible to change a supply destination to which the hydraulic oil is supplied from the oil supply unit 33.

The die driving unit 23 is a mechanism for driving the upper die M2 to advance and retreat it in the elevating direction, and includes a slide 41 on which the upper die M2 is mounted, and a plurality of (in this embodiment, two) slide driving units 42 which support and drive the slide 41. The number of the slide driving units 42 is not limited and may be one.

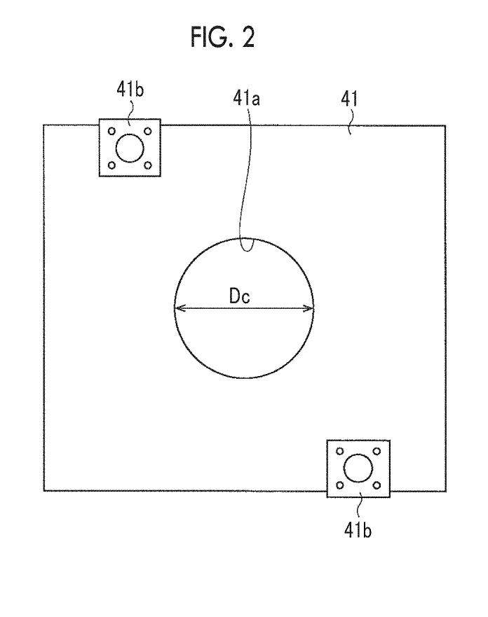

FIG. 2 is a plan view showing the slide. As shown in FIG. 2, the slide 41 is a member having a substantially rectangular shape when viewed in a plan view, and is suspended by the two slide driving units 42. The slide 41 is provided with a hole portion 41a into which the main body portion 32b of the piston 32 can be inserted, and a connection portion 41b to which a suspending part 42a (details will be described later) of the slide driving unit 42 is connected. The shape of the slide 41 when viewed in a plan view is not limited to the rectangular shape and may be appropriately set to another shape, based on the positional relationship with other parts, or the like.

The hole portion 41a is a through-hole extending in the elevating direction at the center of the slide 41 and a peripheral edge (a part of the slide 41) configuring the through-hole, and the center thereof coincides with the central axis of the piston 32. A diameter Dc of the hole portion 41a when viewed in a plan view is equal to or larger than the diameter Db of the tip surface 32c of the main body portion 32b of the piston 32. In a case where the diameter Dc of the hole portion 41a is equal to the diameter Db of the tip surface, if any one of the piston 32 and the slide 41 moves up and down, the piston 32 and the slide 41 slide with respect to each other in the hole portion 41a. That is, the piston 32 and a part of the slide 41, which configures the hole portion 41a, can come into contact with each other. Further, one connection portion 41b of two connection portions 41b is provided in the vicinity of a corner portion of the slide 41. The other connection portion 41b is provided at a position which is point-symmetrical to the one connection portion 41b with respect to the center of the slide 41.

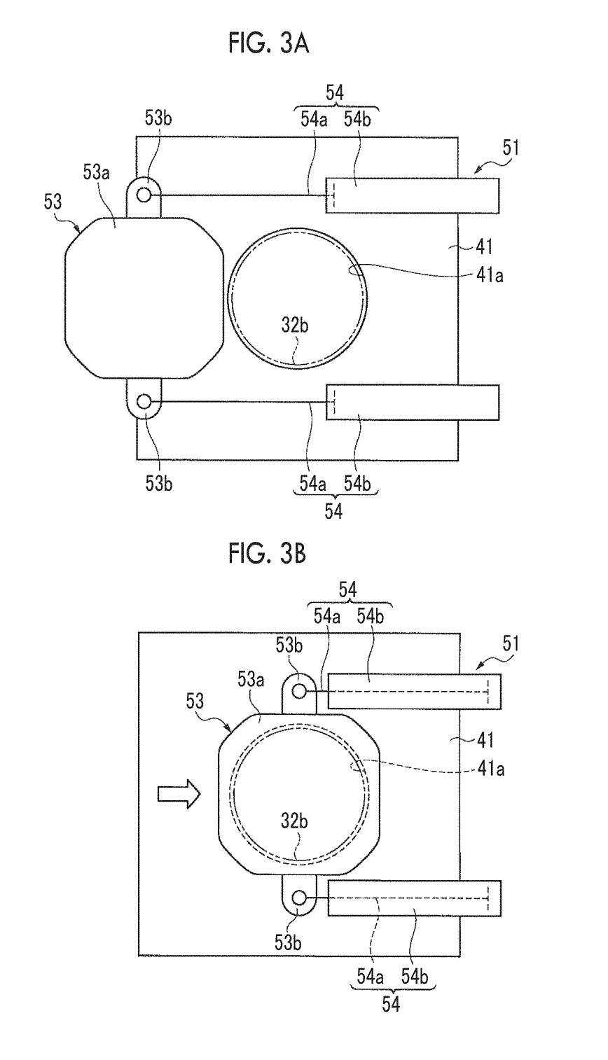

Returning to FIG. 1, a die clamping force transmitting unit 51 which transmits a die clamping force that is generated from the die clamping force generating unit 22 to the upper die M2 is provided on the slide 41. Here, the die clamping force transmitting unit 51 will be described in detail using FIGS. 3A and 3B. FIGS. 3A and 3B are plan views showing a detailed structure of the die clamping force transmitting unit 51, in which FIG. 3A shows a state where the hole portion 41a is exposed and FIG. 3B shows a state where the hole portion 41a is covered with a block body 53.

The die clamping force transmitting unit 51 is a member which is movable between the piston 32 and the slide 41 in the elevating direction and between a position (a first position) where the hole portion 41a is covered to prevent the piston 32 from entering the hole portion 41a and a position (a second position) where it retreats from the first position to allow the piston 32 to enter the hole portion 41a. The die clamping force transmitting unit 51 is a member which receives the die clamping force from the piston 32 when the die clamping force transmitting unit 51 is located at the first position, and transmits the die clamping force to the slide 41. As shown in FIGS. 3A and 3B, the die clamping force transmitting unit 51 includes the block body 53 (a force transmitting body) which is disposed on the slide 41 and has a size to cover the hole portion 41a, and two block body driving units 54 (force transmitting body driving units) which are disposed on the slide 41 and drive the block body 53 in the horizontal direction.

The block body 53 is a member which can directly receive the die clamping force from the piston 32 when it is located at the first position, and includes a main body portion 53a and two ear portions 53b which are connected to the block body driving unit 54. When viewed in a plan view, the area of the main body portion 53a is larger than the area of the hole portion 41a of the slide 41. For this reason, as shown in FIG. 3B, in a case where the main body portion 53a moves to the first position and completely covers the hole portion 41a, at least a part of the main body portion 53a is in contact with the slide 41. As shown in FIG. 3A, in a case where the main body portion 53a moves to the second position, as shown in FIG. 1, the main body portion 32b of the piston 32 can be inserted into the hole portion 41a and the slide 41 can move up such that the upper surface thereof can be located further toward the base end portion 32a side than the tip surface 32c of the piston 32.

The two block body driving units 54 are provided on the slide 41 with the center of the hole portion 41a interposed therebetween, and each has a connection part 54a which is connected to the block body 53, and a driving unit 54b which drives the connection part 54a to advance and retreat it in the horizontal direction. The connection part 54a is a rod-like member which is driven according to the operation of the driving unit 54b, and extends along one direction in the horizontal direction. Further, two connection part 54a extend so as to be parallel to each other. The driving unit 54b is, for example, a hydraulic cylinder, and similar to the hydraulic cylinder 31, hydraulic oil is supplied thereto, whereby the connection part 54a advances and retreats. For this reason, the block body 53 is subjected to translation control by the block body driving units 54. The number of the block body driving units 54 is not limited to two, and one or three or more block body driving units 54 may be provided.

The driving unit 54b pushes out the connection part 54a to the outside, whereby the block body 53 moves away from the driving unit 54b. In this way, as shown in FIG. 3A, the block body 53 is retreated to the second position. Further, the driving unit 54b pulls back the connection part 54a to the inside thereof, whereby the block body 53 comes close to the driving unit 54b. In this way, as shown in FIG. 3B, the block body 53 is advanced to the first position.

Returning to FIG. 1, each of the two slide driving units 42 is a member which advances and retreats the slide 41 in the elevating direction. Each of the two slide driving units 42 includes the suspending part 42a for suspending the slide 41, and a driving unit 42b which drives the suspending part 42a to advance and retreat it in the elevating direction. The suspending part 42a is a rod-like member (a sub-piston) which is driven according to the operation of the driving unit 42b, and extends along the elevating direction. Further, a lower end of the suspending part 42a is connected to a corresponding connection portion 41b (refer to FIG. 2) of the slide 41. The slide driving unit 42 has a hydraulic piston cylinder, and an oil chamber in which the hydraulic oil which is supplied from the oil supply unit 33 is accommodated. For this reason, it can be said that the suspending part 42a moves up and down by the hydraulic oil which is supplied into the driving unit 42b and the slide driving unit 42 has the oil supply unit 33.

A diameter Dd of the sub-piston that is the suspending part 42a is smaller than the diameter Da of the base end portion 32a of the piston 32. Further, the total value of the cross-sectional areas of the sub-pistons of the plurality of slide driving units 42 is smaller than the cross-sectional area of the base end portion 32a of the piston 32. For this reason, in a case where the hydraulic oil in the same condition (amount and pressure) is supplied from the oil supply unit 33 to each of the die clamping force generating unit and the slide driving unit 42, the hydraulic oil supplied to the slide driving unit 42 can drive the slide 41 at high speed. Further, the stroke (the maximum distance in which the slide 41 can advance and retreat) in the slide driving unit 42 is longer than the stroke in the die clamping force generating unit 22.

In this embodiment, the slide 41 and the die clamping force transmitting unit 51 are integrated with each other. For this reason, in a case where the slide 41 advances (moves down) in the elevating direction, the die clamping force transmitting unit 51 moves down by the same amount as the slide 41.

The control unit 5 is a member for controlling the driving of the die clamping force generating unit 22 and the slide driving unit 42, and is, for example, a central processing unit (CPU) or the like. The control unit 5 controls the driving of the die clamping force generating unit 22, for example, by controlling the oil supply to the hydraulic cylinder 31 by the oil supply unit 33. Further, the control unit 5 controls the driving of the slide driving unit 42, for example, by controlling the oil supply to the slide driving unit 42 by the oil supply unit 33. The control of the die clamping force generating unit 22 by the control unit 5 and the control of the slide driving unit 42 by the control unit 5 are independent. For this reason, the piston 32 and the slide 41 can advance in the elevating direction at different timings. That is, due to supplying the hydraulic oil to the slide driving unit 42 and not supplying the hydraulic oil to the die clamping force generating unit 22, the piston 32 can be kept stopped even while the slide 41 moves down. In this embodiment, the control unit 5 controls the slide driving unit 42 such that the slide 41 advances (moves down) in the elevating direction, and then controls the die clamping force generating unit 22 such that the piston 32 advances (moves down) in the elevating direction. The control unit 5 may control the driving of the block body driving unit 54.

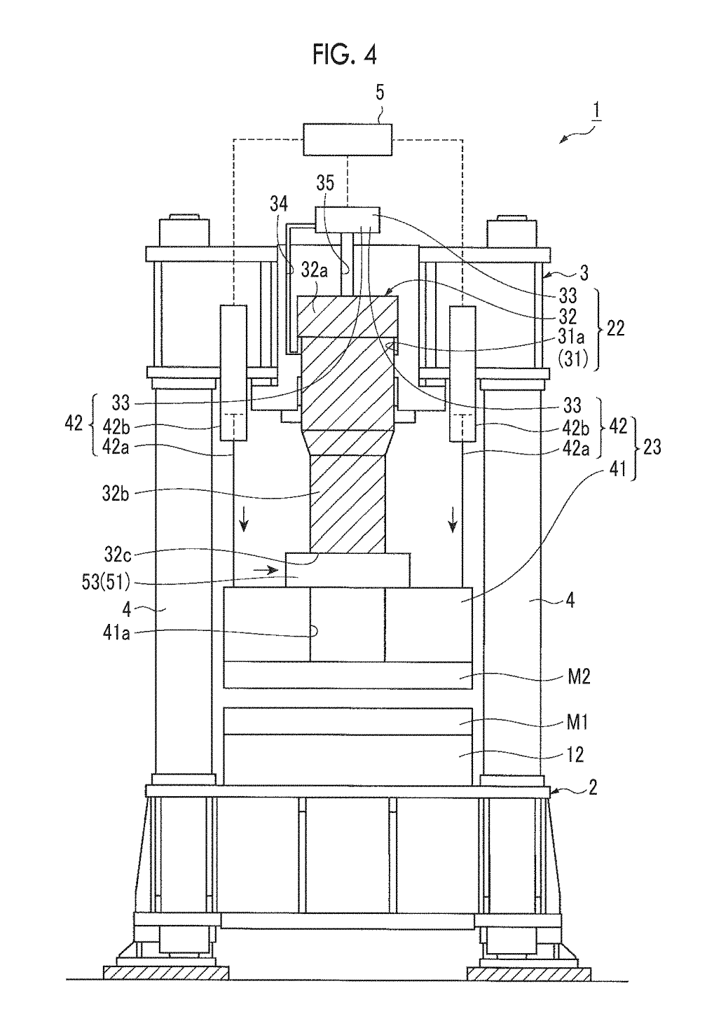

Next, an example of a forming method using the forming apparatus 1 according to this embodiment will be described using FIGS. 4 and 5. FIGS. 4 and 5 are diagrams showing a forming process by the forming apparatus.

First, as a first process, as shown in FIG. 1, the positions of the piston 32 and the slide 41 are set (a preparation process). In the first process, the piston 32 is moved up (retreated) and the suspending part 42a of the slide driving unit 42 is moved up (retreated). At this time, the slide 41 is moved up until the main body portion 32b of the piston 32 can be inserted (enter) into the hole portion 41a of the slide 41. In this way, the distance between the lower die M1 and the upper die M2 in the elevating direction is increased to facilitate loading of a workpiece between the lower die M1 and the upper die M2. In the first process, since the block body 53 of the die clamping force transmitting unit 51 is disposed at the second position on the slide 41, the slide 41 moves up further to the base end portion 32a side than the tip surface 32c of the piston 32 without being obstructed by the block body 53. In this state, the tip surface 32c of the piston 32 is located within the lower end of the hole portion 41a of the slide 41.

Next, as a second process, as shown in FIG. 4, the slide 41 is moved down (advanced) such that the piston 32 is located outside the hole portion 41a of the slide 41 (a slide advancing process). Specifically, after the workpiece is placed on the lower die M1, the suspending part 42a of the slide driving unit 42 moves down to a predetermined position, thereby moving the slide 41 down. In this way, the distance between the lower die M1 and the upper die M2 in the elevating direction is reduced. At this time, since the sub-piston of the slide driving unit 42 has a smaller diameter than the piston 32, the slide 41 moves down at high speed. The slide 41 moving down to a predetermined position corresponds to the slide 41 moving down to a position where the distance between the tip surface 32c of the piston 32 and the slide 41 in the elevating direction is equal to or greater than the thickness of the block body 53.

Further, in the second process, after the slide 41 is moved down, the block body driving unit 54 is controlled to advance the block body 53 to the first position (a block body advancing process). In this way, the block body 53 is disposed between the piston 32 and the slide 41 in the elevating direction. In this embodiment, the block body 53 is in contact with the tip surface 32c of the piston 32 or has a slight gap at the first position.

Next, as a third process, as shown in FIG. 5, the piston 32 is moved down (advanced) (a piston advancing process). In the third process, the pressure associated with the lowering of the piston 32 is transmitted to the block body 53. At this time, the pressure transmitted to the block body 53 is transmitted to the slide 41, and thus the slide 41 moves down. In this way, the distance between the lower die M1 and the upper die M2 is further reduced and the lower die M1 and the upper die M2 are brought into close contact with each other (die-closing). In this state, the upper die M2 is pressed through the piston 32, whereby the lower die M1 and the upper die M2 are subjected to strong die-clamping, and forming of the workpiece is performed. At this time, since the piston 32 has a larger diameter than the sub-piston of the slide driving unit 42, although it is not possible to move the slide 41 down at high speed, it is possible to apply a large force to the slide 41 and the upper die M2 at the time of die-clamping.

After the third process, the piston 32 is moved up (retreated). Subsequently, after the block body 53 is retreated to the second position, the slide 41 is moved up (retreated), whereby the piston 32, the slide 41, and the block body 53 are returned to the places shown in the first process. Finally, the workpiece is recovered from the forming apparatus 1.

As described above, according to the forming apparatus 1 of this embodiment, the piston 32 capable of advancing and retreating in the elevating direction can be inserted into a hole portion 41a provided in the slide 41. In this way, when the slide 41 is retreated further toward the base end portion 32a side than the tip surface 32c of the piston 32, a hole or the like, into which a rod is inserted, may not be provided in the piston 32. Therefore, it is possible to prevent the piston 32 from becoming large in excess of a cross-sectional area that generates the required die clamping force. Further, the forming apparatus 1 is provided with the die clamping force transmitting unit 51 having the block body 53 which transmits the die clamping force from the piston 32 to the slide 41 when the block body 53 is located at the first position where it covers the hole portion 41a to prevent the piston 32 from entering the hole portion 41a. In this way, when the die-clamping of the lower die M1 and the upper die M2 is performed, the block body 53 is located at the first position, whereby the die clamping force from the piston 32 can be favorably transmitted to the upper die M2 through the block body 53 and the slide 41. In addition, since the amount of movement of the piston 32 can be reduced by using the die clamping force transmitting unit 51, the hydraulic cylinder 31 to which the hydraulic oil is supplied in the die clamping force generating unit 22 can also be reduced in size. Therefore, compactification of the die clamping force generating unit 22 having the piston 32 and the hydraulic cylinder 31 can be realized.

Further, according to the forming method using the forming apparatus 1 of this embodiment, in the first process, the slide 41 is retreated further toward the base end portion 32a side than the tip surface 32c of the piston 32. At this time, since the slide 41 can be retreated without providing a hole or the like, into which a rod is inserted, in the piston 32, it is possible to prevent the piston 32 from becoming large in excess of the cross-sectional area which generates the required die clamping force. Further, in the third process, after the block body 53 of the die clamping force transmitting unit 51 is advanced to the first position where the piston 32 is prevented from entering the hole portion 41a in the second process, the piston 32 is moved down to perform die-clamping of the lower die M1 and the upper die M2 through the block body 53 and the slide 41. In this way, the die clamping force from the piston 32 can be favorably transmitted to the upper die M2. In addition, since the block body 53 advances to the first position, whereby the amount of movement of the piston 32 can be reduced, the hydraulic cylinder 31 for driving the piston 32 can also be reduced in size. Therefore, compactification of the die clamping force generating unit 22 having the piston 32 and the hydraulic cylinder 31 can be realized.

Further, when the slide 41 moves up and down (advances and retreats) by the slide driving unit 42, the piston 32 may be slidable with respect to the slide 41 in the hole portion 41a. In this case, the slide 41 and the piston 32 can be independently advanced and retreated.

Further, the forming apparatus 1 is provided with the control unit 5 that controls the driving of each of the die clamping force generating unit 22 and the slide driving unit 42, and the control unit 5 controls the slide driving unit 42 such that the slide 41 advances in the advancing and retreating direction, and then controls the die clamping force generating unit 22 such that the piston 32 advances in the advancing and retreating direction, and therefore, the control unit 5 can independently advance and retreat the slide 41 and the piston 32. For this reason, the control unit 5 can control the driving of the piston 32 so as to apply a high die clamping force to the slide 41 while controlling the slide 41 to be driven at high speed by the slide driving unit 42. In this way, in one forming cycle in the forming apparatus 1, it is possible to achieve both reduction in cycle time and occurrence of a high die clamping force.

Further, since the die clamping force transmitting unit 51 is controlled to advance and retreat in a translation direction orthogonal to the elevating direction, the advancing and retreating direction of the piston 32 and the slide 41 and the advancing and retreating direction of the block body 53 in the die clamping force transmitting unit 51 are orthogonal to each other. In this way, after the slide 41 moves down, the block body 53 can be easily advanced to the first position between the piston 32 and the slide 41.

Further, the slide driving unit 42 has one or a plurality of hydraulic piston cylinders in which the sub-pistons advance and retreat by supplying hydraulic oil thereto, and since the total value of the cross-sectional areas of the sub-pistons is smaller than the cross-sectional area of the piston 32, the sub-piston can be driven at higher speed than the piston 32, although the sub-piston cannot apply larger pressure than the piston 32 to the slide 41. For this reason, the slide driving unit 42 can drive the slide 41 at high speed. In addition, although the piston 32 is driven at lower speed than the sub-piston, the piston can apply larger pressure than the sub-piston to the block body 53, the slide 41, and the like. Therefore, in one forming cycle in the forming apparatus 1, it is possible to achieve both reduction in cycle time due to the high-speed driving of the slide 41 by the slide driving unit 42 and occurrence of a high die clamping force due to the driving of the piston 32.

In addition, by reducing the flow rate per unit time of the hydraulic oil which is supplied to the hydraulic cylinder 31, for example, a prefill valve or the like for supplying and recovering a large amount of hydraulic oil becomes unnecessary. In this way, the number of members configuring the forming apparatus 1 can be reduced.

The preferred embodiment of the present invention has been described above. However, the present invention is not limited to the embodiment described above. For example, in the forming apparatus 1 in the above embodiment, the upper die M2 is not driven and the lower die M1 may be driven. In this case, the forming apparatus 1 is provided with a mechanism for driving the lower die M1 in place of the slide 41 and the slide driving unit 42. Further, both the upper die M2 and the lower die M1 may be driven. Further, the upper die M2 and the like do not need to be necessarily driven along the elevating direction. In other words, the direction in which the dies are put together is not limited to the elevating direction. In this case, the direction in which the block body 53 moves (a perpendicular direction orthogonal to the direction in which the piston 32 and the like advance and retreat) is not limited to the horizontal direction.

Further, as the forming apparatus 1 in the above embodiment and the forming method using the forming apparatus 1, forming other than forging forming, for example, expansion forming described in Japanese Unexamined Patent Publication No. 2015-112608, or the like may be applied. In this case, the forming apparatus 1 includes, in addition to the lower die M1 and the upper die M2, a holding mechanism for holding a workpiece made of a hollow member between the lower die M1 and the upper die M2, a heating mechanism for heating the hollow member, a blow mechanism for blowing high pressure gas into the hollow member, a cooling mechanism for cooling the lower die M1 and the upper die M2, and the like.

In a case of performing the expansion forming by using the forming apparatus 1, for example, die-closing of the lower die M1 and the upper die M2 which are paired is performed and the workpiece disposed between the lower die M1 and the upper die M2 is expansion-formed. In the case of forging forming, forming resistance is generated due to contact between a die and a workpiece, and in order to overcome the forming resistance and further move the upper die M2 down, it is necessary to apply pressure with the piston 32. For this reason, in a case where forging forming of a workpiece is performed with the forming apparatus 1, the piston 32 also has to be moved down by a certain distance, and thus it is necessary to secure a distance for the stroke of the piston 32. In contrast, in a case where expansion forming of a workpiece is performed with the forming apparatus 1, it is favorable if the piston 32 presses the upper die M2 (or the slide 41) through the block body 53 or the like from a state where the upper die M2 (or the slide 41) is completely moved down or immediately before the upper die M2 (or the slide 41) is completely moved down. In this case, the distance for the stroke of the piston 32 may be shorter than that in forging forming or the like, and a time required for the stroke of the piston 32 can be shortened. Therefore, according to the expansion forming using the forming apparatus 1, the die clamping force generating unit 22 having the piston 32 can be made more compact and the forming time can be shortened.

Further, in the embodiment described above, at least one of the slide driving unit 42 and the block body driving unit 54 may be a driving mechanism other than the hydraulic piston cylinder. For example, it may be an electric actuator or the like. Further, the number of each of the slide driving unit 42 and the block body driving unit 54 is not limited to two.

It should be understood that the invention is not limited to the above-described embodiment, but may be modified into various forms on the basis of the spirit of the invention. Additionally, the modifications are included in the scope of the invention.

What is claimed is:

1. A forming apparatus for forming a workpiece by performing die-closing of a pair of dies, the forming apparatus comprising:
a slide on which one of the pair of dies is mounted and which can advance and retreat in an advancing and retreating direction which is a direction toward the other die;
a die clamping force generating unit which includes a piston movable in the advancing and retreating direction by supplying hydraulic oil thereto and generates a die clamping force;
a slide driving unit which advances and retreats the slide in the advancing and retreating direction; and
a die clamping force transmitting unit which transmits the die clamping force from the die clamping force generating unit to the slide,
wherein the slide includes a hole portion into which the piston can be inserted, and
the die clamping force transmitting unit includes
a force transmitting body which is movable between a first position where the force transmitting body covers the hole portion to prevent the piston from entering the hole portion and a second position where the force transmitting body retreats from the first position to allow the piston to enter the hole portion, and transmits the die clamping force from the piston to the slide when the force transmitting body is located at the first position, and
a force transmitting body driving unit which moves the force transmitting body.

2. The forming apparatus according to claim 1, wherein when the slide advances and retreats by the slide driving unit, the piston is slidable with respect to the slide in the hole portion.

3. The forming apparatus according to claim 1, further comprising:
a control unit which controls driving of each of the die clamping force generating unit and the slide driving unit,
wherein the control unit controls the slide driving unit such that the slide advances in the advancing and retreating direction, and then controls the die clamping force generating unit such that the piston advances in the advancing and retreating direction.

4. The forming apparatus according to claim 1, wherein the die clamping force transmitting unit is controlled to advance and retreat in a perpendicular direction orthogonal to the advancing and retreating direction.

5. The forming apparatus according to claim 1, wherein the slide driving unit includes one or a plurality of hydraulic piston cylinders in which sub-pistons advance and retreat by supplying hydraulic oil thereto, and
a total value of cross-sectional areas of the sub-pistons is smaller than a cross-sectional area of the piston.

6. The forming apparatus according to claim 1, wherein the workpiece disposed between the pair of dies is expansion-formed by performing die-closing of the pair of dies.

7. A forming method comprising:
inserting a piston of a die clamping force generating unit into a hole portion provided in a slide;
advancing the slide in a direction in which dies are put together such that the piston is located outside the hole portion of the slide;
advancing a die clamping force transmitting unit to a position between the slide and the piston, which prevents the piston from entering the hole portion;
advancing the piston in the direction in which the dies are put together; and
performing die-clamping of the dies through the die clamping force transmitting unit and the slide.
